(19) United States
(12) Patent Application Publication
(10) Pub. No.: US 2019/0100070 A1
(43) Pub. Date: Apr. 4, 2019

(54) AIR SUSPENSION APPARATUS

(71) Applicant: HITACHI AUTOMOTIVE SYSTEMS, LTD., Ibaraki (JP)

(72) Inventors: Tsutomu ITO, Sagamihara-shi, Kanagawa (JP); Kan KOBAYASHI, Yokohama-shi, Kanagawa (JP)

(21) Appl. No.: 15/525,372

(22) PCT Filed: Nov. 6, 2015
(86) PCT No.: PCT/JP2015/081262

§ 371 Date: May 9, 2017

(30) Foreign Application Priority Data
Nov. 10, 2014 (JP) 2014-228203

(51) Int. Cl. B60G 17/056; B60G 17/052

(52) U.S. Cl. CPC B60G 17/0565; B60G 17/0525; B60G 2600/66; B60G 2500/2012; B60G 2500/2021; B60G 2500/02

(57) ABSTRACT

Provided is a closed type air suspension apparatus requiring no complicated control and capable of simplifying the overall structure. The air suspension apparatus includes a tank storing air, a return valve returning compressed air in an air suspension to the tank, a discharge valve discharging compressed air in the tank to the outside through an intake-discharge port when the compressed air between the intake side of a compressor body and the tank reaches a first value or more, and an intake valve opening when the pressure of the air between the intake side of the compressor body and the tank is at a second value less than the first value, thereby allowing the atmosphere (air) to be taken in from the intake-discharge port. The compressor body of a compressor compresses air including the compressed air in the tank.

### TECHNICAL FIELD

The present invention relates to an air suspension apparatus installed in a vehicle, for example, a four-wheeled automobile.

### BACKGROUND ART

Among vehicles such as four-wheeled automobiles are those which are equipped with air suspension apparatus to perform vehicle height adjustment. Air suspension apparatus of this kind include an open type and a closed type. The open type air suspension apparatus is advantageous in that the system configuration is simple, and, therefore, the number of component parts can be reduced. The open type air suspension apparatus, however, takes a long time to increase the pressure of compressed air to a desired pressure because the open type air suspension apparatus compresses air from the atmospheric pressure state. On the other hand, the closed type air suspension apparatus (for example, see Patent Literature 1) has the advantage that the pressure of compressed air can be increased to a desired pressure in a short time because the pressure of intake air can be kept higher than the atmospheric pressure.

### CITATION LIST

### Patent Literature

Patent Literature 1: Japanese Patent Application Laid-Open Publication No. S62-74704

### SUMMARY OF INVENTION

### Technical Problem

However, the closed type air suspension apparatus disclosed in Patent Literature 1 needs to add a tank, an electromagnetic valve, etc. as compared to the open type air suspension apparatus. Accordingly, the closed type air suspension apparatus suffers from the problem that not only the overall structure becomes complicated, but also the system control becomes complicated.

The present invention has been made in view of the above-described problems of the conventional techniques, and an object of the present invention is to provide an air suspension apparatus requiring no complicated control and capable of simplifying the overall structure.

### Solution to Problem

To solve the above-described problems, there is provided, according to one embodiment of the present invention, an air suspension apparatus including a tank for storing air, a compressor configured to compress the air in the tank, and an air suspension connected to a discharge side of the compressor. The air suspension apparatus further includes a return valve configured to return compressed air in the air suspension to the tank, a discharge valve configured to discharge compressed air in the tank to the outside when compressed air between the intake side of the compressor and the tank reaches a first predetermined value or more, and an intake valve configured to open to take in air from the atmosphere when a pressure of air between the intake side of the compressor and the tank is at a second predetermined value less than the first predetermined value.

### Advantages of Invention

According to one embodiment of the present invention, the overall structure can be simplified.

### BRIEF DESCRIPTION OF DRAWINGS

FIG. 1 is a circuit diagram showing an overall structure of an air suspension apparatus according to a first embodiment.

FIG. 2 is a circuit diagram showing the way in which the vehicle height is raised by supplying compressed air from a compressor to air suspensions.

FIG. 3 is a circuit diagram showing the way in which the vehicle height is lowered by discharging compressed air from the air suspensions.

FIG. 4 is a circuit diagram showing an overall structure of an air suspension apparatus according to a second embodiment.

FIG. 5 is a circuit diagram showing an overall structure of an air suspension apparatus according to a third embodiment.

FIG. 6 is a circuit diagram showing an overall structure of an air suspension apparatus according to a fourth embodiment.

### DESCRIPTION OF EMBODIMENTS

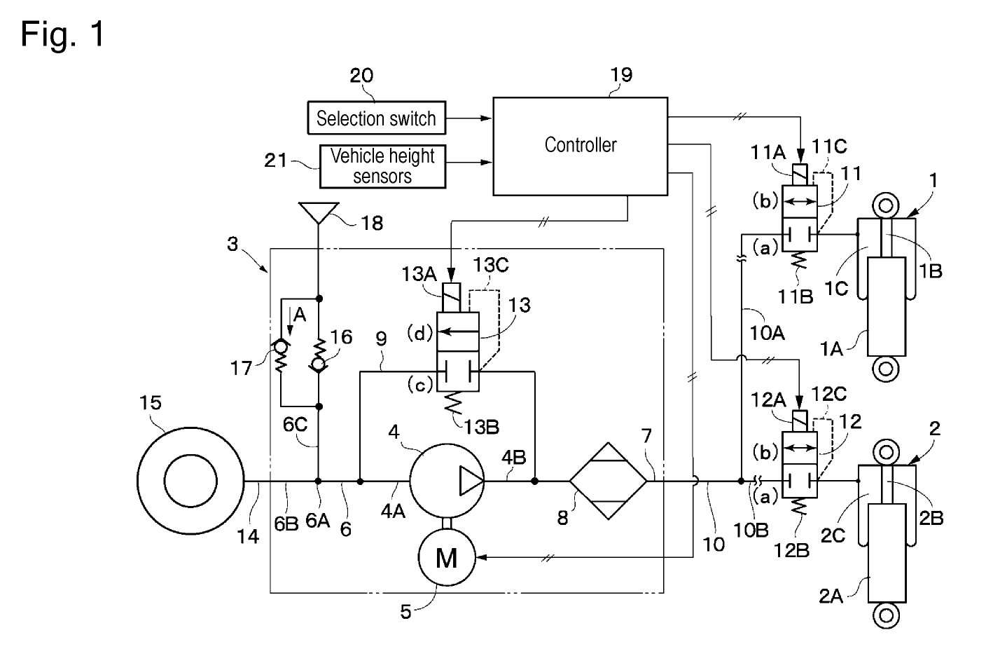

An air suspension apparatus according to each embodiment of the present invention will be explained below in detail with reference to FIGS. 1 to 6 of the accompanying drawings, taking as an example a case where the air suspension apparatus is applied to a vehicle, e.g. a four-wheeled automobile.

Here, FIGS. 1 to 3 show a first embodiment of the present invention. In the figures, reference numerals 1 and 2 denote air suspensions installed in a vehicle. The air suspensions 1 and 2 are provided between axle- and body-side members (both not shown) of the vehicle to perform vehicle height adjustment in response to the supply and discharge of compressed air. Four-wheeled automobiles include those having left and right air suspensions 1 and 2 (a total of two) disposed only on the rear wheel side, for example. It should be noted that embodiments of the present invention are not limited to the above but may have a structure in which a total of four air suspensions are disposed: two on the front wheel side, and two on the rear wheel side, for example.

The air suspension 1 includes a cylinder 1A, for example, secured to the axle-side member of the vehicle, a piston rod 1B extendably and contractibly projecting from an inside of the cylinder 1A in the axial direction and secured at a projecting end thereof to the vehicle body-side member, and an air chamber 1C provided extendably and contractibly between the projecting end of the piston rod 1B and the cylinder 1A to operate as an air spring. The air chamber 1C of the air suspension 1 is axially extended and contracted in response to the supply and discharge of compressed air through a branch pipe 10A, which will be described later. At this time, the air suspension 1 adjusts the height of the vehicle (vehicle height) with the piston rod 1B axially extended from or contracted into the cylinder 1A according to the supply-discharge amount of compressed air. The other air suspension 2 is configured in the same way as the air suspension 1 and includes a cylinder 2A, a piston rod 2B, and an air chamber 2C.

A compressor 3 compresses air and supplies compressed air to the air chambers 1C and 2C of the air suspensions 1 and 2. The compressor 3 is configured to include a compressor body 4 including a reciprocating compressor or a scroll compressor, for example, an electric motor 5 driving the compressor body 4, an intake-discharge line 6 connected to a suction side 4A (hereinafter referred to as an “intake side 4A”) of the compressor body 4, a supply-discharge line 7 connected to a discharge side 4B of the compressor body 4, an air dryer 8 provided in the supply-discharge line 7, a bypass line 9 connecting between the intake side 4A and discharge side 4B of the compressor body 4 while bypassing the compressor body 4, and a return valve 13, which will be described later.

The intake-discharge line 6 of the compressor 3 is configured to include two branch lines 6B and 6C branching from each other at a branch point 6A. One branch line 6B is connected to a tank 15, which will be described later. The other branch line 6C is connected to an intake-discharge port 18 through a discharge valve 16 or an intake valve 17, which will be described later. The compressor body 4 compresses air sucked in from the intake-discharge line 6 and discharges the compressed air toward the air dryer 8. The intake-discharge line 6 also has a function to discharge the compressed air to the outside (into the atmosphere) when the discharge valve 16 opens, as will be described later.

The air dryer 8 is provided halfway in the supply-discharge line 7. The air dryer 8 is, for example, filled therein with a large number of pieces of desiccant (not shown), e.g. silica gel. These pieces of desiccant adsorb therein water contained in the compressed air discharged from the compressor body 4. Therefore, the compressed air having passed through the air dryer 8 is supplied to the air chambers 1C and 2C of the air suspensions 1 and 2 and so forth in the form of dry compressed air.

The air chambers 1C and 2C of the air suspensions 1 and 2 are connected to the supply-discharge line 7 of the air compressor 3 through an air conduit 10. The air conduit 10 is formed to branch off into two branch pipes 10A and 10B, for example. One branch pipe 10A is detachably connected to the air chamber 1C of the air suspension 1; the other branch pipe 10B is detachably connected to the air chamber 2C of the air suspension 2.

Compressed air supply-discharge control valves 11 and 12 control the supply and discharge of the compressed air to and from the air chambers 1C and 2C of the air suspensions 1 and 2. The supply-discharge control valve 11 includes, for example, a 2-port, 2-position electromagnetic switching valve (solenoid valve), which includes a solenoid 11A, a valve spring 11B, and a pilot line 11C. The supply-discharge control valve 11 is normally held in a valve-closed position (a) by the valve spring 11B and switched to a valve-open position (b) against the valve spring 11B when the solenoid 11A is excited by a control signal from a controller 19, which will be described later.

The supply-discharge control valve 11 is provided, for example, at a halfway position in the branch pipe 10A to supply and discharge the compressed air to and from the air chamber 1C of the air suspension 1. It should be noted that the supply-discharge control valve 11 may be provided so as to be connected between the air chamber 1C of the air suspension 1 and the branch pipe 10A. Further, the supply-discharge control valve 11 is provided with a pilot line 11C for relief to function as a relief valve (safety valve). Accordingly, when the pressure in the air chamber 1C exceeds a set pressure of the valve spring 11B, the supply-discharge control valve 11 is temporarily switched from the valve-closed position (a) to the valve-open position (b) even if the solenoid 11A is left unexcited, thereby allowing the excess pressure at this time to be released into the air conduit 10. The other supply-discharge control valve 12 is configured in the same way as the above-described supply-discharge control valve 11. The supply-discharge control valve 12 includes a solenoid 12A, a valve spring 12B, and a pilot line 12C, for example.

The compressor 3 includes the return valve 13 provided in the bypass line 9. The return valve 13 includes, for example, a 2-port, 2-position electromagnetic switching valve (solenoid valve), which includes a solenoid 13A, a valve spring 13B, and a pilot line 13C. The return valve 13 is normally held in a cut-off position (c) by the valve spring 13B and switched to a return position (d) against the valve spring 13B when the solenoid 13A is excited by a control signal from the controller 19, which is described later.

When the return valve 13 is in the cut-off position (c), communication between the intake side 4A and the discharge side 4B of the compressor body 4 through the bypass line 9 is cut off to prevent the compressed air from flowing through the bypass line 9. However, when the return valve 13 is switched to the return position (d), the intake side 4A and the discharge side 4B of the compressor body 4 are communicated with each other through the bypass line 9. Consequently, the compressed air in the supply-discharge line 7 is returned to the intake-discharge line 6 through the bypass line 9. That is, the compressed air in the air suspensions 1 and 2 is returned toward the tank 15, which will be described later, through the bypass line 9 and the return valve 13.

The return valve 13 is provided with a pilot line 13C for relief to function also as a relief valve. Accordingly, when the pressure at the discharge side 4B of the compressor body 4 exceeds a set pressure of the valve spring 13B, the return valve 13 functions as a relief valve to be switched from the cut-off position (c) to the return position (d) to function even if the solenoid 13A is left unexcited, thereby allowing the excess pressure at this time to be released to the intake side 4A of the compressor body 4 through the bypass line 9. On the other hand, when the pressure at the discharge side 4B of the compressor body 4 becomes lower than the set pressure of the valve spring 13B, the return valve 13 is switched from the return position (d) back to the cut-off position (c) by the biasing force of the valve spring 13B.

A tank 15 is detachably provided in one branch line 6B of the intake-discharge line 6 through an external piping 14 formed, for example, of a flexible hose and the like. The external piping 14 extends from the distal end of the branch line 6B toward the outside of the compressor 3, and the distal end of the external piping 14 is detachably connected to the tank 15. The tank 15 includes, for example, a reserve tire (i.e. spare tire) usually mounted on a vehicle. The tank 15 stores air therein.

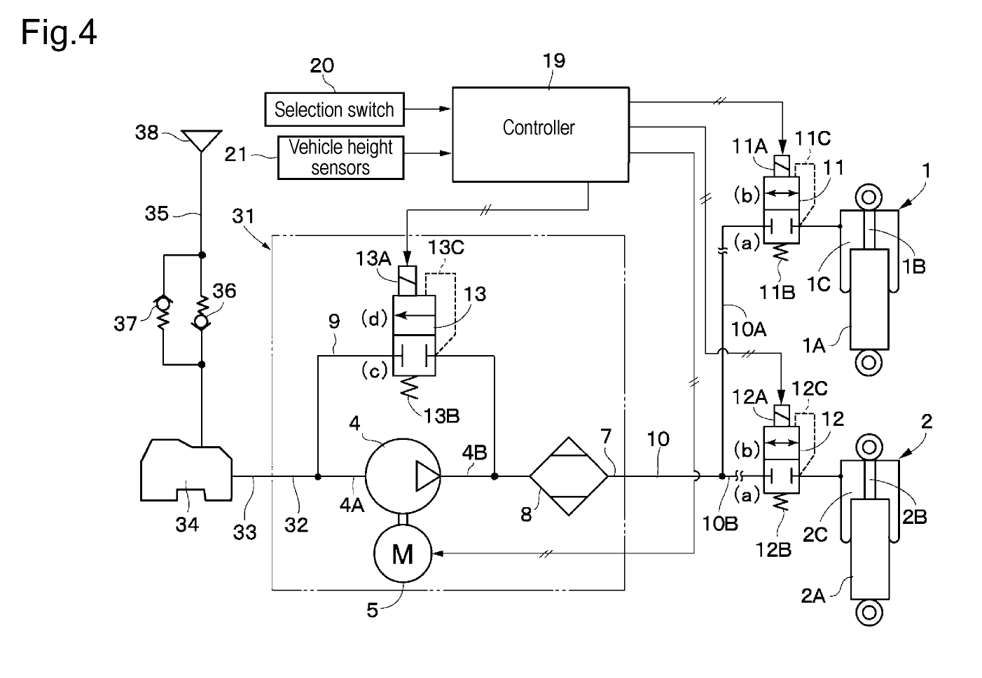

The compressor body 4, when driven by the electric motor 5, sucks the air from the tank 15 through the intake-discharge line 6, and compresses the sucked air and discharges the compressed air toward the supply-discharge line 7. It should be noted that the tank 15 is not limited to a spare tire but may, for example, be a tank made of a resin as in a second embodiment shown in FIG. 4. It is also possible to use various tanks other than the above, e.g. an airtight container mountable on a vehicle.

In the other branch line 6C of the intake-discharge line 6, a discharge valve 16 and an intake valve 17 are provided in a parallel relation to each other. The discharge valve 16 and the intake valve 17 are provided in the compressor 3 so as to constitute a part of the compressor 3. The distal end of the branch line 6C is provided with an intake-discharge port 18 opening to the outside of the compressor 3. The intake-discharge port 18 is provided with a filter (not shown) removing dust and the like from the air. The discharge valve 16 and the intake valve 17 are provided in a parallel connection to each other between the branch point 6A of the intake-discharge line 6 and the intake-discharge port 18.

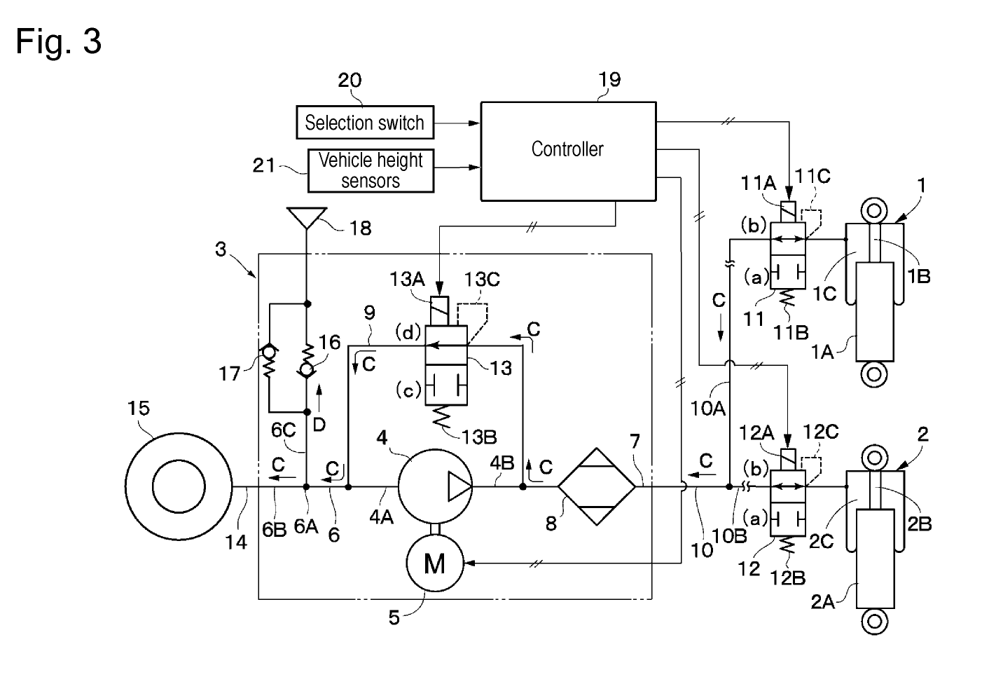

The discharge valve 16 includes a pressure setting type check valve or the like which allows the high-pressure compressed air to be discharged (to flow) from the branch point 6A of the intake-discharge line 6 toward the intake-discharge port 18 but prevents reverse flow of the compressed air. That is, the discharge valve 16 opens when the pressure of the compressed air between the intake side 4A of the compressor body 4 and the tank 15 becomes not less than a first predetermined value P1 (e.g. P1=250 kPa=0.25 MPa), thereby allowing the compressed air in the tank 15 to be discharged from the intake-discharge port 18 to the outside in the direction of arrow D in FIG. 3.

The intake valve 17, which is connected in parallel to the discharge valve 16, functions as a so-called suction valve, and includes a check valve or the like which allows the air to flow from the intake-discharge port 18 toward the branch line 6C (i.e. toward the branch point 6A side of the intake-discharge line 6) but prevents reverse flow of the air. The intake valve 17 opens when the pressure of the air between the intake side 4A of the compressor body 4 and the tank 15 becomes not more than a second predetermined value P2 (e.g. atmospheric pressure) which is sufficiently lower than the first predetermined value P1. Consequently, the outside air (atmospheric air) is taken in from the intake-discharge port 18 so as to be sucked into the intake-discharge line 6 and the intake side 4A of the compressor body 4 in the direction of arrow A in FIG. 1. Chattering of the intake valve 17 can be prevented by setting the valve-opening pressure of the intake valve 17 sufficiently lower than the first predetermined value P1, as stated above.

The controller 19 as a control device includes, for example, a microcomputer or the like. To the input side of the controller 19 are connected a selection switch 20, a plurality of vehicle height sensors 21, and so forth. The selection switch 20 is used to switch among various modes for vehicle height adjustment, for example, an automatic mode, and an optional mode in which the driver changes the vehicle height as he or she likes. The vehicle height sensors 21 individually detect vehicle heights as adjusted by the air suspensions 1 and 2. The output side of the controller 19 is connected to an operating relay of the electric motor 5, the solenoids 11A and 12A of the supply-discharge control valves 11 and 12, the solenoid 13A of the return valve 13, and so forth.

The controller 19 performs drive control of the electric motor 5 based on signals from the selection switch 20, the vehicle height sensors 21, and so forth. In addition, the controller 19 outputs control signals to the solenoids 11A and 12A of the supply-discharge control valves 11 and 12 and to the solenoid 13A of the return valve 13 to excite or de-excite the solenoids 11A, 12A and 13A individually. By so doing, the supply-discharge control valves 11 and 12 are switched to either of the valve-closed position (a) and the valve-open position (b), and the return valve 13 is switched to either of the cut-off position (c) and the return position (d).

The following is an explanation of the operation of the air suspension apparatus according to the first embodiment having the above-described structure.

For example, when the pressure in the tank 15, which includes a spare tire or the like, has decreased to a pressure close to the atmospheric pressure, the compressor body 4 is rotationally driven by the electric motor 5. As a result, the pressure at the intake side 4A of the compressor body 4 becomes less than the atmospheric pressure (i.e. becomes not more than the second predetermined value P2); therefore, the intake valve 17 opens. Consequently, the outside air (atmospheric air) is sucked from the intake-discharge port 18 through the intake-discharge line 6 toward the intake side 4A of the compressor body 4 in the direction of arrow A in FIG. 1, and the compressed air is discharged to the discharge side 4B of the compressor body 4. The compressed air flows toward the supply-discharge line 7, and the air dryer 8 dries the compressed air passing therethrough. This is the same as in the open type.

Next, to raise the vehicle height by a method described later when the tank 15 has been filled with the compressed air at a pressure not more than the first predetermined value P1, the controller 19 performs drive control of the electric motor 5 based on signals from the selection switch 20, the vehicle height sensors 21, and so forth, and outputs control signals to the solenoids 11A and 12A of the supply-discharge control valves 11 and 12. Consequently, the electric motor 5 rotationally drives the compressor body 4, and the compressor body 4 sucks the compressed air stored in the tank 15 from the intake side 4A and, discharges the higher-pressure compressed air to the discharge side 4B.

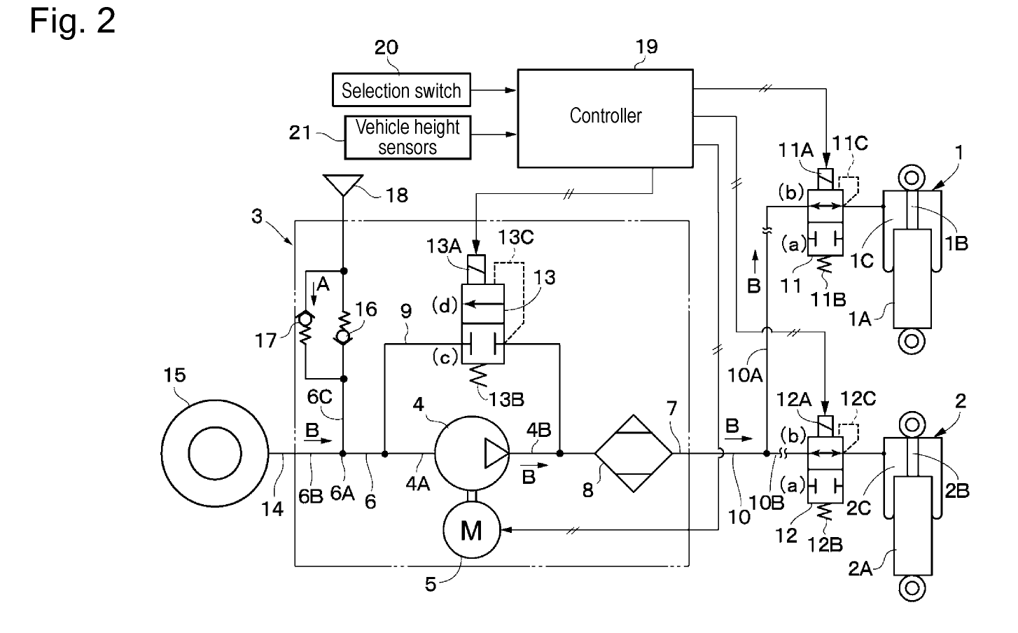

When, in this state, the supply-discharge control valves 11 and 12 are switched from the valve-closed position (a) to the valve-open position (b), with the return valve 13 left in the cut-off position (c), the high-pressure compressed air flows in the direction of arrow B in FIG. 2 from the discharge side 4B of the compressor body 4 into the air chambers 1C and 2C of the air suspensions 1 and 2 through the supply-discharge line 7, the air dryer 8 and the branch pipes 10A and 10B of the air conduit 10. At this time, the compressed air is supplied to the air suspensions 1 and 2 in the state of being dried by the air dryer 8.

In this case, the compressor body 4 can suck the compressed air previously stored in the tank 15 from the intake side 4A, and can supply the higher-pressure compressed air from the discharge side 4B into the air chambers 1C and 2C of the air suspensions 1 and 2. Accordingly, the high-pressure compressed air can be supplied into the air chambers 1C and 2C of the air suspensions 1 and 2 rapidly in a short time, and hence it is possible to extend the air suspensions 1 and 2 rapidly to raise the vehicle height. Accordingly, the vehicle height can be raised rapidly and efficiently as compared to conventional open type air suspension apparatus (for example, a type of air suspension apparatus in which the air is compressed by a compressor from the atmospheric pressure).

Next, when judging that a target vehicle height has been reached based on detection signals from the vehicle height sensors 21, the controller 19 outputs, in order to terminate the vehicle height raising operation, control signals to de-excite the solenoids 11A and 12A of the supply-discharge control valves 11 and 12, thereby returning the supply-discharge control valves 11 and 12 to the valve-closed position (a). Consequently, the supply-discharge line 7 of the compressor 3 is cut off from the air chambers 1C and 2C of the air suspensions 1 and 2. Accordingly, the air suspensions 1 and 2 operate as air springs to maintain the above-described target vehicle height, thereby allowing the vehicle to be kept in a state where the vehicle height has been raised as stated above. At this time, the electric motor 5 of the compressor 3 may stop driving to stop the compression operation.

On the other hand, to lower the vehicle height, the controller 19 outputs control signals to excite the solenoids 11A and 12A of the supply-discharge control valves 11 and 12 and the solenoid 13A of the return valve 13, with the compressor body 4 stopped by the electric motor 5. Consequently, the supply-discharge control valves 11 and 12 are switched from the valve-closed position (a) to the valve-open position (b) against the valve springs 11B and 12B, and the return valve 13 is switched from the cut-off position (c) to the return position (d) against the valve spring 13B.

Accordingly, the compressed air in the air chambers 1C and 2C of the air suspensions 1 and 2 is discharged toward the air conduit 10 and the supply-discharge line 7 in the direction of arrow C in FIG. 3, and when passing (flowing backward) through the air dryer 8, the compressed air operates to regenerate the desiccant in the air dryer 8. The discharged air (compressed air) is led to the intake-discharge line 6 in the direction of arrow C in FIG. 3 through the return valve 13, which is in the return position (d), and through the bypass line 9 to bypass the compressor body 4, and stored in the tank 15.

At this time, if the pressure in the tank 15 becomes an excess pressure (i.e. not less than the first predetermined value P1), the discharge valve 16 opens, thereby allowing the excess pressure to be discharged from the intake-discharge port 18 to the outside in the direction of arrow D in FIG. 3. Therefore, the pressure in the tank 15, which includes a spare tire, is held at a pressure not more than the first predetermined value P1 and cannot increase to a pressure greater than the first predetermined value P1.

When judging that the target vehicle height has been reached based on the detection signals from the vehicle height sensors 21, the controller 19 outputs, in order to terminate the vehicle height lowering operation, control signals to de-excite the solenoids 11A and 12A of the supply-discharge control valves 11 and 12 and the solenoid 13A of the return valve 13, thereby returning the supply-discharge control valves 11 and 12 to the valve-closed position (a), and returning the return valve 13 to the cut-off position (c). Consequently, the supply-discharge line 7 of the compressor 3 is cut off from the air chambers 1C and 2C of the air suspensions 1 and 2. Accordingly, the air suspensions 1 and 2 operate as air springs to maintain the target vehicle height, thereby allowing the vehicle to be kept in a state where the vehicle height has been lowered as stated above.

Next, an explanation will be made taking as an example a case where the selection switch 20 is actuated to perform vehicle height adjustment in the automatic mode. Here, the term “GVW condition” means a vehicle loaded condition (i.e. a condition in which a vehicle carries a full complement of passengers and luggage at the maximum carrying capacity). On the other hand, the term “CARB condition” means a vehicle unloaded condition in which a vehicle has all passengers and all luggage unloaded therefrom (i.e. a condition in which a vehicle carries only engine oil, coolant, and fuel as standard equipment).

When the vehicle condition changes from a GVW (loaded) condition to a CARB (unloaded) condition, the vehicle height increases by an amount corresponding to a reduction in the weight of the vehicle because the air chambers 1C and 2C of the air suspensions 1 and 2 operate as air springs. Accordingly, the controller 19 performs control to contract (lower) the air chambers 1C and 2C of the air suspensions 1 and 2 until a target standard vehicle height is reached, as follows.

An explanation will be made taking as an example a case where the pressure in the air suspensions 1 and 2 (air chambers 1C and 2C) is, for example, 400 kPa as a whole and the air volume thereof is 2.9 L in a CARB (unloaded) condition, and where the air suspension volume (i.e. the air volume of the air chambers 1C and 2C) at a standard vehicle height is 2.4 L. In this case, the pressure in the air suspensions 1 and 2 (air chambers 1C and 2C) is approximately constant while the vehicle height is changing due to the change in vehicle condition from the GVW (loaded) condition to the CARB (unloaded) condition. Therefore, a vehicle having air suspensions 1 and 2 for only the rear wheels needs to discharge (2.9 L−2.4 L)×2=1.0 L of air at a pressure of about 400 kPa.

A gauge pressure of 400 kPA is 500 kPa in terms of absolute pressure, and the air volume in a volume of 1 L at an absolute pressure of 500 kPa is 5 L. On the other hand, a 2 L tank at the atmospheric pressure (about 100 kPa in terms of absolute pressure) contains 2 L of air. When all 5 L of air enters the 2 L tank, the total air volume becomes 7 L. When a total of 7 L of air enters the 2 L tank, the pressure becomes 350 kPa, which is 250 kPa in terms of gauge pressure. Accordingly, a closed circuit (closed system circuit) is established by setting the valve-opening pressure (set pressure) of the discharge valve 16 to the first predetermined value P1 (e.g. 250 kPa). The pressure increases by about 250 kPa.

If it becomes necessary to cause a vehicle height change outside the assumed vehicle height adjustment range, the pressure in the tank 15 may exceed 250 kPa. In such a case, however, the compressed air at a pressure not less than 250 kPa (first predetermined value P1), for example, opens the discharge valve 16, thereby being discharged into the atmosphere from the intake-discharge port 18.

In other words, the first predetermined value P1 may be set to a value not more than a pressure value (e.g. 250 kPa) which is reached when all of an air suspension volume, which increases as the vehicle condition changes from a state where the tank is at the atmospheric pressure and the vehicle is in a GVW condition to a state where the vehicle is in a CARB condition, of air enters the tank 15. At this time, in order for the air suspensions 1 and 2 to lower the vehicle height to a standard vehicle height predetermined in a stationary state, the compressed air at the above-described pressure value is discharged from the air chambers 1C and 2C of the air suspensions 1 and 2 toward the tank 15. Thus, a closed type air suspension apparatus can be realized which includes the tank 15, the compressor 3, and the air suspensions 1 and 2.

Next, when the vehicle condition changes from the CARB (unloaded) condition to a loaded condition in which the vehicle carries passengers and luggage again, the air chambers 1C and 2C of the air suspensions 1 and 2 are contracted as the vehicle weight increases. Consequently, the vehicle height becomes lower than the target standard vehicle height. Therefore, at this time, in order to raise the vehicle height to the target vehicle height (standard vehicle height), the controller 19 controls the compressor 3, the supply-discharge control valves 11 and 12, and so forth to extend (raise) the air chambers 1C and 2C of the air suspensions 1 and 2.

In this case, the compressor body 4 of the compressor 3 can suck the compressed air stored in the tank 15 (e.g. compressed air at 250 kPa) from the intake side 4A, and generate the higher-pressure compressed air at the discharge side 4B. Thus, the compressor 3 can rapidly supply the compressed air into the air chambers 1C and 2C of the air suspensions 1 and 2. In other words, the compressor 3 sucks not atmospheric-pressure air but the compressed air stored in the tank 15, which has been pre-compressed, and thus can generate the higher-pressure compressed air. Accordingly, it is possible to reduce the time required to increase the pressure of the compressed air, and the air chambers 1C and 2C of the air suspensions 1 and 2 can be extended (raised) rapidly.

For example, if the weight of passengers and luggage is heavier than the assumed load when the vehicle is in a GVW (loaded) condition, the pressure (i.e. the pressure at the intake side 4A) may decrease to the atmospheric pressure by the compressed air being sucked from the tank 15 while the compressor 3 is continuing to supply the compressed air into the air chambers 1C and 2C of the air suspensions 1 and 2. In such a case, however, by setting the intake valve 17 to open at a pressure not more than the second predetermined value P2 (e.g. an atmospheric pressure, which is 0 kPa), the compressor 3 can suck an amount of air needed to compensate for the shortage of air for compression, thus ensuring a necessary intake air volume.

The first predetermined value P1, which is the valve-opening pressure of the discharge valve 16, and the second predetermined value P2 (P2<P1), which is the valve-opening pressure of the intake valve 17, are values which can be appropriately set for each vehicle equipped with the air suspension apparatus. Once the first predetermined value P1 and the second predetermined value P2 are initially set, the set values need not be changed thereafter.

Thus, the air suspension apparatus according to the first embodiment includes the tank 15 storing air, the return valve 13 returning the compressed air in the air suspensions 1 and 2 (the air chambers 1C and 2C) to the tank 15, the discharge valve 16 discharging the compressed air in the tank 15 to the outside through the intake-discharge port 18 when the compressed air between the intake side 4A of the compressor body 4 and the tank 15 reaches a first predetermined value P1 or more, and the intake valve 17 opening to allow the atmosphere (air) to be taken in from the intake-discharge port 18 when the pressure of the air between the intake side 4A of the compressor body 4 and the tank 15 is at a second predetermined value P2 less than the first predetermined value P1 (P2<P1). The compressor body 4 of a compressor 3 is configured to compress the air including the compressed air in the tank 15.

Therefore, the air suspension apparatus according to the first embodiment can realize a closed circuit (closed type) capable of storing the compressed air in the tank 15 and supplying the compressed air stored in the tank 15 to the air suspensions 1 and 2 while further compressing the compressed air by the compressor 3. Further, the compressed air discharged from the air chambers 1C and 2C of the air suspensions 1 and 2 can be returned to and stored in the tank 15 by using the return valve 13, without releasing the compressed air into the atmosphere. Thus, the compressed air can be effectively utilized, without being discharged uselessly.

Further, in the air suspension apparatus according to the first embodiment, the compressor body 4 sucks and compresses the compressed air in the tank 15. Therefore, it is possible to reduce considerably the frequency at which the air suspension apparatus sucks air from the outside atmosphere (i.e. the frequency at which the intake valve 17 is opened), and hence possible to reduce the frequency of occurrence of failure due to sucking in dust or water from the atmosphere. In addition, it is not particularly essential to use a pressure sensor or the like to perform pressure control and so forth, and it is not necessary to perform a complicated control and hence possible to simplify the overall structure, as compared to the conventional closed type air suspension apparatus.

Further, because the set pressure of the discharge valve 16 can be adjusted at will, the tank 15 need not have high pressure resistance as compared to conventional tanks for high-pressure application and, therefore, can be reduced in weight and cost. Accordingly, a reserve tire (i.e. spare tire) usually mounted on a vehicle, for example, can be used as the tank 15 storing compressed air. Thus, it is possible to reduce the installation space and the manufacturing cost.

Therefore, it is possible according to the first embodiment to provide a closed type system requiring no complicated control. It is also possible to minimize the number of electromagnetic switching valves used as the supply-discharge control valves 11 and 12 and the return valve 13. Moreover, because the tank 15 need not take into consideration the pressure-resistance performance thereof (high pressure) and can be constituted by a reserve tire (spare tire), a closed system can be realized at a reduced cost. When a reserve tire (spare tire) is used as the tank 15, the set pressure of the discharge valve 16 is preferably the set pressure of the reserve tire. Further, when a reserve tire is used, a working pressure of the tire can be obtained by opening the return valve 13 and operating the compressor body 4 for a predetermined time through a switch operation at the driver's seat. Thus, the pressure of the reserve tire can be adjusted to a desired value; therefore, the spare tire can be used immediately when a tire normally used is punctured.

Further, according to the first embodiment, the air suspension apparatus can be operated as a closed system within a normal use range where the pressure in the tank 15 is not more than the first predetermined value P1, and it is possible to reduce the vehicle height raising time during normal use (i.e. during high frequency use). In addition, only when the vehicle height adjustment range exceeds the normal use range, the atmospheric air can be taken in (the intake valve 17 is opened) or the compressed air can be released into the atmosphere (the discharge valve 16 is opened), according to need.

Next, FIG. 4 shows a second embodiment of the present invention. The feature of the second embodiment resides in that a discharge valve and an intake valve are provided so as to be connected to a tank outside a compressor. It should be noted that, in the second embodiment, the same constituent elements as those of the first embodiment are denoted by the same reference numerals as those used in the first embodiment, and a description thereof is omitted.

A compressor 31 employed in the second embodiment is configured to include a compressor body 4, an electric motor 5, a supply-discharge line 7, an air dryer 8, a bypass line 9, and a return valve 13, in the same way as the compressor 3 stated in the description of the first embodiment. However, the compressor 31 in this case differs from the intake-discharge line 6 stated in the description of the first embodiment in that an intake-discharge line 32 connected to an intake side 4A of the compressor body 4 is connected to a tank 34, which will be described later, through an external piping 33.

The external piping 33 is formed by using a flexible hose or the like approximately in the same way as the external piping 14 stated in the description of the first embodiment. It should, however, be noted that when the tank 34 need not be detached from the vehicle, the external piping 33 may be formed by a rigid pipe, e.g. a metal pipe. The external piping 33 extends from the distal end of the intake-discharge line 32 toward the outside of the compressor 3, and the distal end of the external piping 33 is detachably connected to the tank 34.

Here, the tank 34 is formed by using a tank made of a synthetic resin. Thus, the tank 34 allows selection of a tank profile according to an installation space (space) in the vehicle and so forth and permits its profile to be easily changed at the stage of design (manufacture). The tank 34 is configured to have approximately the same volume as that of the tank 15 stated in the description of the first embodiment. However, the resin tank 34 may have a volume larger or smaller than that of the spare tire.

The tank 34 is connected with an intake-discharge pipe 35 for sucking the outside air (or for discharging the compressed air) separately from the external piping 33, and a discharge valve 36 and an intake valve 37 are provided halfway in the intake-discharge pipe 35 in a parallel relation to each other. That is, the discharge valve 36 and the intake valve 37 in this case are provided to the tank 34 outside the compressor 31. The distal end of the intake-discharge pipe 35 is provided with an intake-discharge port 38 opening into the atmosphere outside the tank 34, and the intake-discharge port 38 is provided with a filter (not shown) removing dust and the like from the air. The discharge valve 36 and the intake valve 37 are provided in a parallel connection to each other at an intermediate point in the intake-discharge pipe 35 between the tank 34 and the intake-discharge port 38.

Here, the discharge valve 36 includes a pressure setting type check valve or the like similar to the discharge valve 16 stated in the description of the first embodiment. The discharge valve 36 opens when the pressure (pressure of the compressed air) in the tank 34 becomes not less than a first predetermined value P1 (e.g. P1=250 kPa), thereby allowing the compressed air in the tank 34 to be discharged from the intake-discharge port 38 to the outside.

The intake valve 37 includes a check valve or the like functioning as a so-called suction valve in the same way as the intake valve 17 stated in the description of the first embodiment. The intake valve 37 opens when the pressure of the air in the tank 34 becomes not more than a second predetermined value P2 (e.g. atmospheric pressure). Consequently, the outside air (atmospheric air) is taken in from the intake-discharge port 38 so as to be sucked to the intake side 4A of the compressor body 4 through the intake-discharge pipe 35 and the tank 34.

Thus, also in the second embodiment configured as stated above, it is possible to realize a closed circuit (closed type) that can store the compressed air, which is compressed by the compressor 31, in the tank 34 and that can further compress the compressed air stored in the tank 34 by the compressor 31 and supply it to the air suspensions 1 and 2. Thus, advantages similar to those of the first embodiment are achieved.

Particularly, according to the second embodiment, the tank 34, which is provided outside the compressor 31 together with the discharge valve 36 and the intake valve 37, is formed as a tank made of a resin, thereby allowing a tank profile to be selected according to an installation space (space) for the tank 34 in the vehicle, and so forth. Thus, the tank 34 permits its profile to be easily changed at the stage of design (manufacture).

It should be noted that the second embodiment has been explained taking as an example a case where the tank 34, which is provided outside the compressor 31, is a tank made of a resin. However, embodiments of the present invention are not limited thereto. For example, the tank may be formed by using a spare tire as in the first embodiment. It is also possible to use various tanks, e.g. an airtight container mountable on a vehicle.

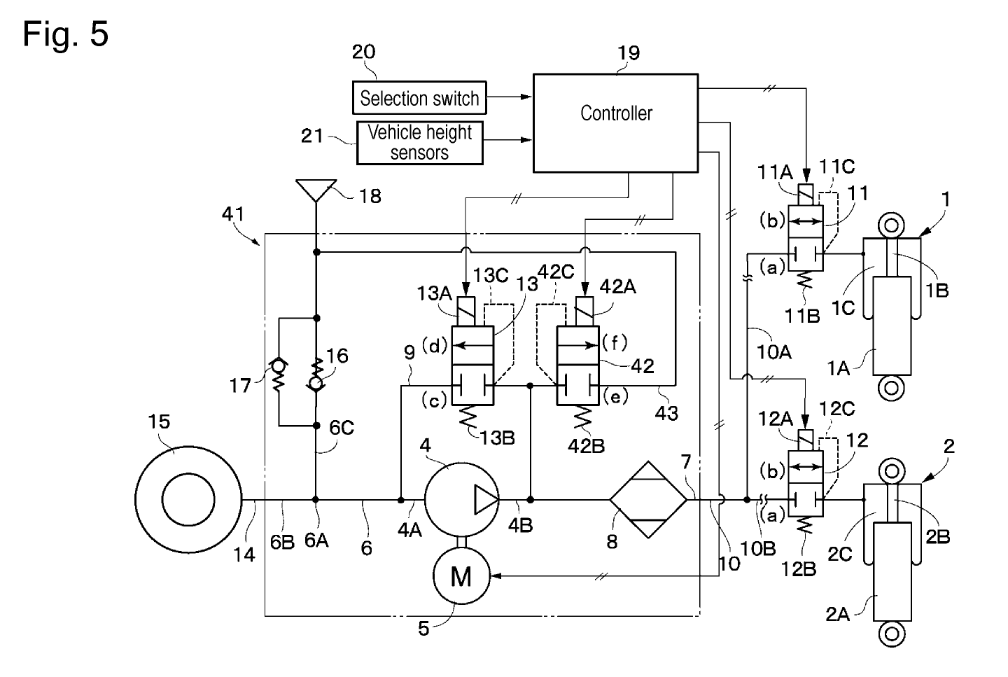

Next, FIG. 5 shows a third embodiment of the present invention. The feature of the third embodiment resides in that an air suspension apparatus is provided with a rapid discharge device for rapidly discharging compressed air in air suspensions into the atmosphere. It should be noted that, in the third embodiment, the same constituent elements as those of the first embodiment are denoted by the same reference numerals as those used in the first embodiment, and a description thereof is omitted.

Here, a compressor 41 employed in the third embodiment is configured to include a compressor body 4, an electric motor 5, an intake-discharge line 6, a supply-discharge line 7, an air dryer 8, a bypass line 9, and a return valve 13, in the same way as the compressor 3 stated in the description of the first embodiment. However, the compressor 41 in this case differs from the compressor 3 stated in the description of the first embodiment in that a discharge valve 42 is additionally provided as a rapid discharge device.

The discharge valve 42 as a rapid discharge device is provided between the discharge side 4B of the compressor body 4 and the air dryer 8 through a discharge line 43. The distal end (downstream) side of the discharge line 43 is connected to the branch line 6C near the intake-discharge port 18. The discharge valve 42 includes an electromagnetic switching valve approximately similar to the return valve 13, which has a solenoid 42A, a valve spring 42B, and a pilot line 42C. The discharge valve 42 is normally held in a cut-off position (e) by the valve spring 42B, and switched to a discharge position (f) against the valve spring 42B when the solenoid 42A is excited by a control signal from a controller 19.

That is, the discharge valve 42, when in the cut-off position (e), cuts off communication between a portion between the discharge side 4B of the compressor body 4 and the air dryer 8 and the intake-discharge port 18 through the discharge line 43, thereby preventing the compressed air from flowing through the discharge line 43. However, when the discharge valve 42 is switched from the cut-off position (e) to the discharge position (f), the portion between the discharge side 4B of the compressor body 4 and the air dryer 8 is communicated with the intake-discharge port 18 through the discharge line 43. Consequently, the compressed air at the supply-discharge line 7 side is discharged into the outside air from the intake-discharge port 18 through the discharge line 43. Thus, a rapid discharge of the compressed air takes place.

For example, when the vehicle height is to be lowered rapidly during running of the vehicle, the supply-discharge control valves 11 and 12 are switched from the valve-closed position (a) to the valve-open position (b) and the discharge valve 42 is switched from the cut-off position (e) to the discharge position (f), with the return valve 13 held in the cut-off position (c), thereby allowing the compressed air in the air chambers 1C and 2C of the air suspensions 1 and 2 to be rapidly discharged into the atmosphere from the intake-discharge port 18 through the supply-discharge line 7, the air dryer 8 and the discharge line 43. As a result, the air chambers 1C and 2C of the air suspensions 1 and 2 can be contracted rapidly, and thus the vehicle height can be lowered rapidly.

Also when the vehicle height is lowered rapidly as stated above, the compressed air discharged from the air suspensions 1 and 2 passes (flows backward) through the air dryer 8 to flow into the discharge line 43. Thus, water can be removed from the desiccant filled in the air dryer 8, and the desiccant can be regenerated.

Thus, with the third embodiment configured as stated above, when a rapid discharge is to be performed through the discharge valve 42, first, the return valve 13 is switched to the return position (d), and after a given time has elapsed, the return valve 13 is returned to the cut-off position (c), and the discharge valve 42 is switched from the cut-off position (e) to the discharge position (f), thereby enabling a rapid discharge. While the return valve 13 is in the return position (d), the compressed air can be returned to the tank 15, and the compressed air in the tank 15 can be used to raise the vehicle height next time.

That is, in such a case, the compressed air compressed by the compressor 41 can be stored in the tank 15, and the compressed air stored in the tank 15 can be further compressed air by the compressor 41 and supplied to the air suspensions 1 and 2. Thus, advantages similar to those of the first embodiment are achieved.

It should be noted that the third embodiment has been explained taking as an example a case where the discharge valve 42 is provided with the pilot line 42C for relief to allow the discharge valve 42 to function also as a relief valve. However, the discharge valve 42 in this case need not necessarily operate as a relief valve but may be formed by using an electromagnetic switching valve having no relief function. That is, when the pressure at the discharge side 4B of the compressor body 4 becomes an excess pressure, the return valve 13 is switched from the cut-off position (c) to the return position (d) as a relief valve and thus can release the excess pressure at this time to the intake side 4A of the compressor body 4 through the bypass line 9.

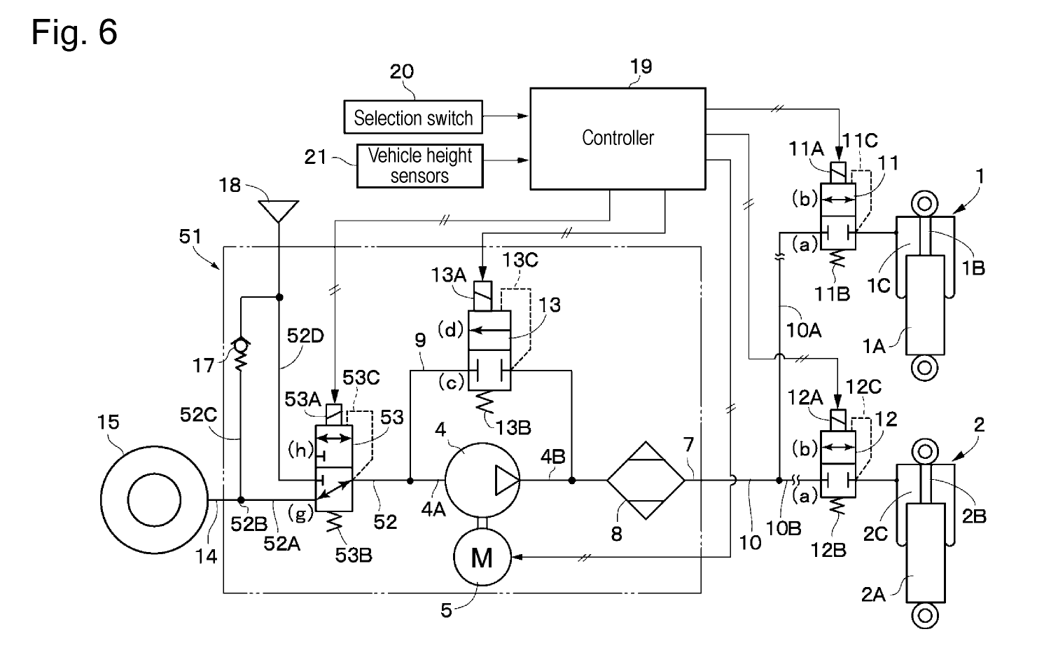

Next, FIG. 6 shows a fourth embodiment of the present invention. The feature of the fourth embodiment resides in that a three-way valve is used to form a discharge valve that discharges compressed air in a tank to the outside when the compressed air reaches a pressure not less than a first predetermined value. It should be noted that, in the fourth embodiment, the same constituent elements as those of the first embodiment are denoted by the same reference numerals as those used in the first embodiment, and a description thereof is omitted.

Here, a compressor 51 employed in the fourth embodiment is configured to include a compressor body 4, an electric motor 5, a supply-discharge line 7, an air dryer 8, a bypass line 9, and a return valve 13, in the same way as the compressor 3 stated in the description of the first embodiment. However, the compressor 51 in this case differs from the compressor 3 stated in the description of the first embodiment in that the compressor 51 includes an intake-discharge line 52 and a three-way valve 53 as a discharge valve.

The intake-discharge line 52 of the compressor 51 is configured to include a first line section 52A connected to a tank 15 through an external piping 14, a second line section 52C branching from the first line section 52A at a branch point 52B and connected at the distal end side thereof to an intake-discharge port 18, and a third line section 52D connected to the intake-discharge port 18 in a parallel relation to the first and second line sections 52A and 52C. The second line section 52C is provided at an intermediate portion thereof with an intake valve 17 as stated in the description of the first embodiment.

The three-way valve 53, which forms a discharge valve, is provided at an intake side 4A of the compressor body 4 through the intake-discharge line 52 to selectively connect either of the first and third line sections 52A and 52D to the intake side 4A of the compressor body 4. The three-way valve 53 includes, for example, a 3-port, 2-position electromagnetic switching valve, which has a solenoid 53A, a valve spring 52B, and a pilot line 53C. The three-way valve 53 is normally held in a first position (g) by the valve spring 53B and switched to a second position (h) against the valve spring 53B when the solenoid 53A is excited by a control signal from a controller 19.

That is, the three-way valve 53, when in the first position (g), allows the intake side 4A of the compressor body 4 to communicate with the tank 15 through the first line section 52A and the external piping 14, thereby permitting discharge of the compressed air to the tank 15 or suction (intake) of the compressed air from the tank 15 by the compressor 51. On the other hand, when switched from the first position (g) to the second position (h), the three-way valve 53 allows the intake side 4A of the compressor body 4 to communicate with the intake-discharge port 18 through the third line section 52D of the intake-discharge line 52.

Particularly, in the three-way valve 53, the set pressure of the valve spring 53B is set to the first predetermined value P1 (e.g. P1=250 kPa) stated in the description of the first embodiment so that the three-way valve 53 operates as a discharge valve. Because the three-way valve 53 has the pilot line 53C, when the pressure at the intake side 4A of the compressor body 4 exceeds the set pressure of the valve spring 53B, the three-way valve 53 is switched from the first position (g) to the second position (h) against the biasing force of the valve spring 13B by the pressure from the pilot line 53C, with the solenoid 53A left unexcited.

Thus, the intake side 4A of the compressor body 4 is communicated with the outside air through the third line section 52D and the intake-discharge port 18, and the pressure at the intake side 4A decreases rapidly. However, when the pressure at the intake side 4A decreases to a pressure not higher than the set pressure (first predetermined value P1) of the valve spring 53B, the three-way valve 53 is returned from the second position (h) back to the first position (g) by the valve spring 53B.

In other words, the three-way valve 53 is switched from the first position (g) to the second position (h) against the valve spring 13B by the pressure from the pilot line 53C, with the solenoid 53A left unexcited, thereby suppressing the pressure of the compressed air in the tank 15 (i.e. the pressure at the intake side 4A of the compressor body 4) from increasing to a pressure not less than the first predetermined value P1. When the pressure at the intake side 4A decreases to a pressure not higher than the set pressure (first predetermined value P1) of the valve spring 53B, the three-way valve 53 is automatically returned from the second position (h) to the first position (g). Thus, the three-way valve 53 operates to maintain the pressure in the tank 15 at a pressure not more than the first predetermined value P1.

Thus, the fourth embodiment configured as stated above includes the three-way valve 53 as the discharge valve and further includes the discharge device configured such that after the compressed air in the air suspensions 1 and 2 has been returned to the tank 15 by placing the three-way valve 53 in the first position (g), the three-way valve 53 is switched to the second position (h) to cut off between the air suspensions 1 and 2 and the tank 15 to close the communication therebetween, and the three-way valve 53 releases the compressed air in the air suspensions 1 and 2 into the atmosphere.

Thus, the fourth embodiment can realize a closed circuit (closed type) in which while the three-way valve 53 is held in the first position (g) by the valve spring 53B, the compressed air (compressed air in the air suspensions 1 and 2) compressed by the compressor 51 can be stored in the tank 15, and the compressed air stored in the tank 15 can be further compressed by the compressor 51 and supplied to the air suspensions 1 and 2. Thus, advantages similar to those of the first embodiment are achieved.

Particularly, according to the fourth embodiment, when the compressed air from the air suspensions 1 and 2 is discharged to the tank 15 through the bypass line 9 and so forth to lower the vehicle height, with the supply-discharge control valves 11 and 12 switched to the valve-open position (b) and the return valve 13 switched to the return position (d), if the pressure of the compressed air in the tank 15 (i.e. the pressure at the intake side 4A of the compressor body 4) reaches a pressure not less than the first predetermined value P1, the three-way valve 53 is switched from the first position (g) to the second position (h), with the solenoid 53A left unexcited.

Accordingly, the pressure in the tank 15 can be held at a pressure not more than the first predetermined value P1. When the pressure at the intake side 4A decreases to a pressure not higher than the set pressure (first predetermined value P1) of the valve spring 53B, the three-way valve 53 is automatically returned from the second position (h) to the first position (g), thereby making it possible to prevent the compressed air from being uselessly discharged toward the third line section 52D.

Thus, according to the fourth embodiment, the three-way valve 53 is switched to the second position (h) against the valve spring 13B by the pressure from the pilot line 53C even if the solenoid 53A is left unexcited, and the three-way valve 53 operates as a discharge valve. Thus, it is possible to discharge the compressed air in the air suspensions 1 and 2 into the atmosphere while suppressing the pressure in the tank 15 from being released into the atmosphere by cutting off the tank 15-side circuit (first line section 52A).

When a rapid discharge is to be performed through the three-way valve 53, the return valve 13 is switched to the return position (d) by a control signal from the controller 19 and the solenoid 53A is excited to switch the three-way valve 53 to the second position (h). Consequently, the intake side 4A of the compressor body 4 is communicated with the intake-discharge port 18 through the third line section 52D, and the compressed air in the air suspensions 1 and 2 can be rapidly discharged into the atmosphere.

According to one embodiment of the present invention, the first predetermined value at which the discharge valve opens may be set to a value not more than a pressure value (e.g. 250 kPa) which is reached when all of an air suspension volume, which increases as the vehicle condition changes from a state where the tank is at the atmospheric pressure and the vehicle is in a GVW condition to a state where the vehicle is in a CARB condition, of air enters the tank 15, the air suspension volume. With this structure, a closed type air suspension apparatus can be realized which includes a tank, a compressor, and air suspensions.

Further, according to one embodiment of the present invention, the discharge valve is provided in the compressor. With this structure, the discharge valve, which opens when the compressed air in the tank reaches a pressure not less than the first predetermined value, can be provided in the compressor. Meanwhile, the discharge valve may be provided to the tank. In this case, the discharge valve can be provided outside the compressor, so that the structure of the compressor can be simplified.

Further, according to one embodiment of the present invention, the air suspension apparatus includes a rapid discharge device configured to, after the compressed air in the air suspensions is temporarily returned to the tank, cut off between the air suspension and the tank to close the communication therebetween, and release the compressed air in the air suspension into the atmosphere. With this structure, when a rapid discharge from the air suspensions is to be performed, first, the return valve is switched to the return position, and after a given time has elapsed, the return valve is returned to the cut-off position, and the rapid discharge device is switched to the discharge position, thereby enabling a rapid discharge. While the return valve is in the return position, the compressed air can be returned to the tank, and the compressed air in the tank can be used to raise the vehicle height next time.

Further, according to one embodiment of the present invention, a three-way valve is used as the discharge valve, and the air suspension apparatus includes the discharge device configured to, after the compressed air in the air suspension is returned to the tank, close between the air suspensions and the tank and release the compressed air in the air suspension into the atmosphere. With this structure, when the compressed air is to be discharged from the air suspension toward the tank to lower the vehicle height, if the pressure of the compressed air in the tank reaches a pressure not less than the first predetermined value, the three-way valve as the discharge valve can be switched to a position for releasing the compressed air in the air suspension into the atmosphere, with the solenoid left unexcited.

Further, according to one embodiment of the present invention, the tank need not have high pressure resistance as compared to conventional high-pressure tanks and, therefore, can be reduced in weight and cost. Accordingly, it is possible to reduce the installation space and the manufacturing cost. In addition, a spare tire can be used as the above-described tank.

Although some embodiments of the present invention have been described above, the described embodiments of the present invention are for the purpose of facilitating the understanding of the present invention and are not intended to limit the present invention. The present invention may be modified and improved without departing from the spirit thereof, and the present invention includes equivalents thereof. In addition, the elements described in the claims and the specification can be arbitrarily combined or omitted within a range in which the above-mentioned problems are at least partially solved, or within a range in which at least a part of the advantages is achieved.

The present application claims priority to Japanese Patent Application No. 2014-228203 filed on Nov. 10, 2014. The entire disclosure of Japanese Patent Application No. 2014-228203 filed on Nov. 10, 2014 including the specification, the claims, the drawings and the summary is incorporated herein by reference in its entirety.

### LIST OF REFERENCE SIGNS

1, 2: air suspension; 3, 31, 41, 51: compressor; 4: compressor body; 5: electric motor; 6, 32, 52: intake-discharge line; 7: supply-discharge line; 8: air dryer; 9: bypass line; 10: air conduit; 11, 12: supply-discharge control valve; 13: return valve; 15, 34: tank; 16, 36: discharge valve; 17, 37: intake valve; 42: discharge valve (rapid discharge device); 53: three-way valve (discharge valve, discharge device).

1. An air suspension apparatus comprising:
a tank configured to store air;
a compressor configured to compress the air supplied from the tank;
an air suspension connected to a discharge side of the compressor;
a return valve configured to return compressed air in the air suspension to the tank;
a discharge valve which is a pressure setting type check valve configured to discharge the air in the tank to an outside when a pressure of the air between an intake side of the compressor and the tank becomes not less than a first value; and
an intake valve which is a pressure setting type check valve configured to open to take in air from an atmosphere when the pressure of the air between the intake side of the compressor and the tank is at a second value less than the first value.

2. The air suspension apparatus of claim 1, wherein the first value is set to not more than a minimum pressure value when the air suspension is in a stationary state.

3. The air suspension apparatus of claim 1, wherein the discharge valve is provided in the compressor.

4. The air suspension apparatus of claim 1, wherein the discharge valve is provided so as to be connected to the tank outside the compressor.

5. The air suspension apparatus of claim 1, further comprising:
a rapid discharge device configured to, after the compressed air in the air suspension is returned to the tank, close between the air suspension and the tank and release the compressed air in the air suspension into the atmosphere.

6. The air suspension apparatus of claim 1, wherein the discharge valve is a three-way valve;
the air suspension apparatus further comprising:
a discharge device configured to, after the compressed air in the air suspension is returned to the tank, close between the air suspension and the tank and release the compressed air in the air suspension into the atmosphere.

7. The air suspension apparatus of claim 1, wherein a spare tire is used as the tank.
